(19) United States
(12) Patent Application Publication
(10) Pub. No.: US 2025/0065761 A1
(43) Pub. Date: Feb. 27, 2025

(54) INFORMATION PROCESSING SYSTEM, INFORMATION PROCESSING APPARATUS AND METHOD

(71) Applicant: Ubiden, Inc., Tokyo (JP)

(72) Inventors: Norio Yamaguchi, Tokyo (JP); Tatsuro Shiraishi, Tokyo (JP); Shuhei Onishi, Tokyo (JP); Hitoshi Ikeda, Tokyo (JP)

(73) Assignee: Ubiden, Inc., Tokyo (JP)

(21) Appl. No.: 18/455,713

(22) Filed: Aug. 25, 2023

(51) Int. Cl. B60L 53/66; B60L 53/65

(52) U.S. Cl. CPC B60L 53/665; B60L 53/65

(57) ABSTRACT

When multiple services are provided by a plurality of provision business-operators to the same service provision target in the same service provision area, it can be realized to improve convenience for users, convenience for provision business-operators, or both. An information processing system performs an information processing regarding a service provided to a moving body or a user of the moving body as the service provision target. The information processing system comprises a detection section for performing a detection of the service provision target existing in the service provision area where the multiple types of services are respectively provided by the plurality of provision business-operators, and a fee-charge processing section for performing a process necessary for fee-charging collectively usage fees of the multiple types of services provided to the service provision target detected by the detection section, to the user.

### TECHNICAL FIELD

The present invention relates to information processing systems, information processing apparatuses, and methods for performing an information processing regarding a service provided to a moving body or a user of the moving body as a service provision target.

### BACKGROUND ART

Conventionally, as this type of information processing system, a system is known that supplies an electric power from an electrical outlet to an electric vehicle (moving body) of the user and charges a usage fee thereof to the user. For example, Patent Document 1 discloses an information processing system provided with a power-supply gate apparatus that controls a power supply by receiving the electric power supplied from a power line, a server apparatus (information processing apparatus) that manages a use of the electric power supplied from the power-supply gate apparatus, a mobile outlet that connects the power-supply gate apparatus and the electric vehicle. The mobile outlet is equipped with a power usage integrator for measuring how much electric power the electric vehicle uses. After the electric power from the power-supply gate apparatus is output from the mobile outlet and supplied to the electric vehicle, a current power supply amount (supply amount information) detected by the power usage integrator is transmitted from the mobile outlet to the server apparatus, and then the server apparatus calculates a usage fee of the electric power from the received power usage amount.

### CITATION LIST

### Patent Literature

Patent Literature 1: Japanese Unexamined Patent Application Publication No. 2002-325357.

### SUMMARY OF INVENTION

### Technical Problem

In recent years, in addition to a power supply service for the electric vehicle (moving body), various services provided to the moving body or the user of moving body as the service provision target are proposed, multiple types of services may be provided by a plurality of provision business-operators to the same service provision target in the same service provision area. In such a case, if the plurality of provision business-operators may perform process for fee-charging individually for multiple types of services provided to the same service provision target, or the service provision target using these multiple types of services may pay a fee (provision fee) individually to each of the plurality of provision business-operators, a convenient for the service provision target, the provision business-operator, or both is lacked.

### Solution to Problem

An information processing system according to an aspect of the present invention is an information processing system for performing an information processing regarding a service provided to a moving body or a user of the moving body as a service provision target, and comprises a detection section for performing a detection of the service provision target existing in a service provision area where multiple types of services are respectively provided by a plurality of provision business-operators, and a fee-charge processing section for performing a process necessary for fee-charging collectively usage fees of the multiple types of services provided to the service provision target detected by the detection section, to the user.

The foregoing information processing system may comprise a payment processing section for performing a process necessary for paying provision fees of the multiple types of services provided to the service provision target detected by the detection section, to each of the plurality of provision business-operators.

An information processing system according to another aspect of the present invention is an information processing system for performing an information processing regarding a service provided to a moving body or a user of the moving body as a service provision target, and comprises a detection section for detecting the service provision target existing in a service provision area where multiple types of services are respectively provided by a plurality of provision business-operators, and a payment processing section for performing a process necessary for paying provision fees of the multiple types of services provided to the service provision target detected by the detection section, to each of the plurality of provision business-operators.

In the foregoing information processing system, the detection section may perform the detection by acquiring detection information obtained by detecting a passage of the service provision target to the service provision area by a gate apparatus disposed at least one of an entrance and an exit of the service provision area.

In the foregoing information processing system, the detection section may perform the detection based on position information of the service provision target and position information of the service provision area.

In the foregoing information processing system, the multiple types of services may include at least one of a parking-space rental service for the moving body, an energy supply service to the moving body, and an additional service provided in conjunction with the energy supply service to the moving body. The additional service may include an energy rapid-supply service in which a fee-charging is performed for a use of rapid-supply of supplying an energy to the moving body at a high speed.

An information processing apparatus according to still another aspect of the present invention is an information processing apparatus for performing an information processing regarding a service provided to a moving body or a user of the moving body as a service provision target, and comprises a fee-charge processing section for performing a process necessary for fee-charging collectively usage fees of multiple types of services provided to the service provision target that is detected by a detection section as existing in a service provision area where the multiple types of services are respectively provided by a plurality of provision business-operators, to the user.

An information processing apparatus according to still another aspect of the present invention is an information processing apparatus for performing an information processing regarding a service provided to a moving body or a user of the moving body as a service provision target, and comprises a payment processing section for performing a process necessary for paying provision fees of multiple types of services provided to the service provision target that is detected by a detection section as existing in a service provision area where the multiple types of services are respectively provided by a plurality of provision business-operators, to each of the plurality of provision business-operators.

A method according to still another aspect of the present invention is a method for performing an information processing regarding a service provided to a moving body or a user of the moving body as a service provision target, and comprises performing a detection of the service provision target existing in a service provision area where multiple types of services are respectively provided by a plurality of provision business-operators, and performing a process necessary for fee-charging collectively usage fees of the multiple types of services provided to the detected service provision target, to the user.

A method according to still another aspect of the present invention is a method for performing an information processing regarding a service provided to a moving body or a user of the moving body as a service provision target, and comprises detecting the service provision target existing in a service provision area where multiple types of services are respectively provided by a plurality of provision business-operators, and performing a process necessary for paying provision fees of the multiple types of services provided to the detected service provision target, to each of the plurality of provision business-operators.

### ADVANTAGEOUS EFFECTS OF INVENTION

According to the present invention, when the multiple services are provided by the plurality of provision business-operators to the same service provision target in the same service provision area, it can be realized to improve convenience for users, convenience for provision business-operators, or both.

### BRIEF DESCRIPTION OF DRAWINGS

FIG. 1 is an explanatory diagram showing a disposing area in which an electrical outlet configuring a service management system according to an embodiment 1 is disposed.

FIG. 2 is an explanatory diagram showing an example of a schematic configuration of the service management system according to the embodiment 1.

FIG. 3 is a block diagram showing an example of a configuration of main functions of a server which configures the service management system according to the embodiment 1.

FIG. 4 is a sequence diagram showing an example of a process in the service management system according to the embodiment 1.

FIG. 5 is an explanatory diagram showing a disposing area in which an electrical outlet configuring a service management system according to an embodiment 2 is disposed.

FIG. 6 is an explanatory diagram showing an example of a schematic configuration of the service management system according to the embodiment 2.

FIG. 7 is a block diagram showing an example of a configuration of main functions of a server which configures the service management system according to the embodiment 2.

FIG. 8 is a sequence diagram showing an example of a process in the service management system according to the embodiment 2.

### DESCRIPTION OF EMBODIMENTS

### Embodiment 1

Hereinafter, an embodiment of the present invention (hereinafter, this embodiment will be referred to as “embodiment 1”) is described with reference to the drawings.

A system according to the present embodiment of the present invention is an information processing system for performing an information processing regarding multiple types of services provided to a moving body or a user of the moving body as a service provision target. The multiple types of services for which the information processing is performed by the present system are services provided to the moving body or the user of moving body existing in the same service provision area, if each service is provided by a different provision business-operator, contents of the services are not limited.

The moving body may be a moving body moving on the ground such as an electric vehicle or a fuel cell vehicle, a moving body moving through the air such as a drone, or a moving body such as a ship moving on water such as the sea. The moving body may be a vehicle having four or more wheels, a three-wheeled vehicle (tricycle), a two-wheeled vehicle (motorcycle, bicycle), a truck, a bus, a private vehicle, a commercial vehicle, or the like.

The services of the present embodiment include, for example, a parking-space rental service for the moving body, an energy supply service to the moving body, an additional service provided in conjunction with the energy supply service to the moving body, a maintenance service for a maintenance, a cleaning, or the like of the moving body, and a facility usage service for the user who visit by the moving body, etc., but are not limited thereto.

The parking-space rental service for the moving body is a service in which a usage fee is charged for parking the moving body in the rented parking space, for typically example, if the moving body is a vehicle, the service includes a parking service such as hourly parking and monthly parking. If the moving body is a bicycle, the service includes a bicycle parking service such as hourly bicycle parking and monthly bicycle parking.

In addition, the energy supply service to the moving body is a service that charges a fee for supplying the energy to the moving body, for typically example, if the moving body is a gasoline-powered vehicle, the service includes a refueling service that charges a usage fee according to an amount of gasoline refueled into the vehicle (energy supply amount). It is noted that the energy to be supplied to the moving body may be, for example, a primary energy in the form of oil, natural gas, coal, or the like, or a secondary energy in the form of electricity, hydrogen, gasoline, light oil, heavy oil, city gas, alcohol, or the like.

Additionally, the additional service provided in conjunction with the energy supply service to the moving body includes, for example, an energy rapid-supply service that charges a fee for a use of rapid-supply in which the energy is supplied to the moving body at a high speed. This energy rapid-supply service is, for example, a service that charges for a benefit (value) of completing the energy supply in a shorter time even when receiving the same amount of energy. Further, since a facility capable of such rapid-supply is usually more expensive than a facility capable of slow-supply, it can also be said to be a fee-charge service that includes a usage fee for such expensive facility.

In addition, the maintenance service for the moving body is a service that charges a fee for treatment, such as repair, maintenance, and cleaning, performed on the moving body, and includes a service that charges a fee according to a maintenance content such as repair, maintenance, cleaning, etc. of the moving body.

In addition, the facility usage service for the user who visit by the moving body is a service that charges a usage fee of the facility (for example, an entertainment facility such as zoo and amusement park, a dining facility such as restaurant, an accommodation facility such as hotel, etc.), to the user who visit by the moving body.

In the present embodiment 1, as an example, the moving body is an electric car (vehicle), and a system (service management system) for performing an information processing regarding a provision of time-rental parking service in which the parking space in the parking place is rented, and a provision of electrical charging service in which a battery of the vehicle is supplied (charged) an electric power from a charging facility in the parking place, will be explained as an example.

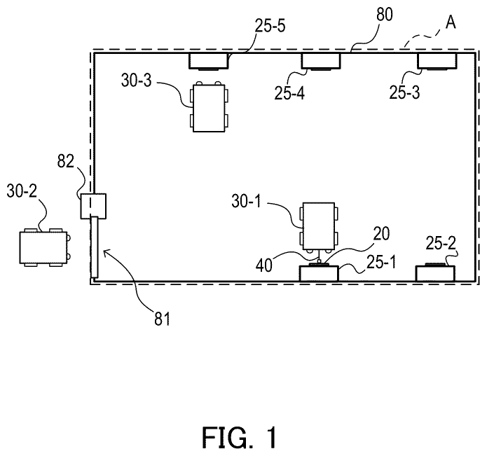

FIG. 1 is an explanatory diagram showing a service provision area in which the parking service and the electrical charging service managed by a service management system 10 according to the present embodiment 1 is provided.

The service provision area A shown in FIG. 1 is a site of a parking place 80 having parking spaces in which a plurality of vehicles 30-1 to 30-3 can be parked. A location where the vehicles 30-1 to 30-3 can enter and exit the parking place 80 is one entrance/exit gate 81. A gate apparatus 82 is disposed at the entrance/exit gate 81 of the parking place 80. This gate apparatus 82 has a function of identifying and detecting vehicles 30 entering and exiting the parking place 80 (service provision area).

In the parking place 80, each of power-charging stands 25-1 to 25-5, which includes an electrical outlet 20, is disposed near the parking space. In the example of FIG. 1, although five power-charging stands 25-1 to 25-5 are disposed in the parking place 80, the number of power-charging stands disposed in the parking place is arbitrary, and may be one or more. It is noted that the service provision area A in the present embodiment 1 is outdoors, but may be indoors.

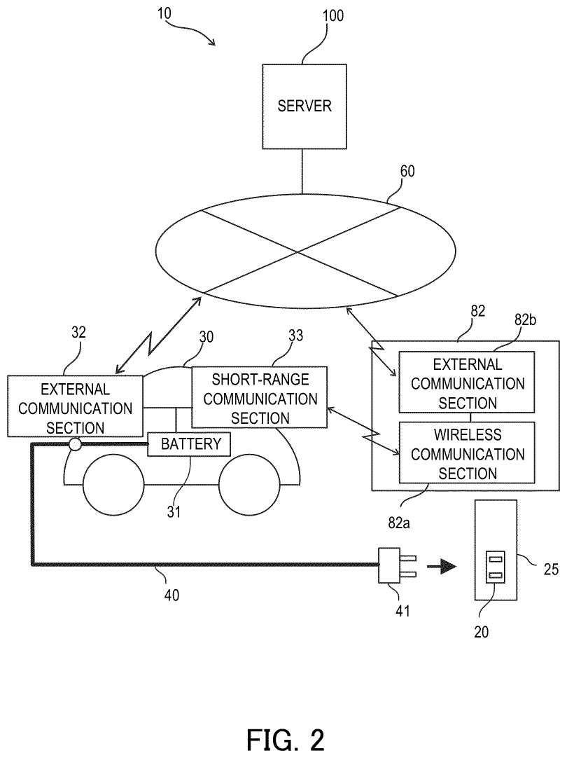

FIG. 2 is an illustration showing an example of a schematic configuration of the service management system 10 according to the present embodiment 1.

In FIG. 2, the service management system 10 manages a provision of the time-rental parking service in which the parking space in the parking place 80 is rented, and a provision of the electrical charging service in which a battery 31 of the vehicle 30 is supplied (charged) the electric power from the electrical outlet 20 in the parking place 80. The power supply from the electrical outlet 20 is performed via, for example, a wired power cable 40 and a plug 41. The power supply from the electrical outlet 20 may be performed by a wireless power supply such as a power supply by an electromagnetic induction, magnetic field sympathetic vibration or magnetic field resonance (magnetic resonance) technology, a radio wave such as a microwave, or the like, and a power supply by a light such as a laser light. It is noted that even when the wireless power supply is performed, an individual identification number of the electric vehicle can be obtained. Further, the voltage (current) supplied from the electrical outlet 20 may be alternating current or direct current.

The service management system 10 includes a server 100 as an information processing apparatus that performs an information processing regarding the provision of time-rental parking service and the provision of electrical charging service. The server 100 may be configured with a single computer apparatus, may be configured with a plurality of computer apparatuses cooperated with each other, or may be configured with a cloud system on a network.

The electrical outlet 20 as an energy output section capable of outputting an electric power (electrical energy) may be a general-purpose outlet with no limitation of use, or may be a dedicated outlet with a limitation of use. Further, the electrical outlet 20 may be an electrical outlet for which a user is not limited, or an electrical outlet that can be used only by a specific user.

The gate apparatus 82 disposed at the entrance/exit gate 81 of the parking place 80 includes a wireless communication section 82a capable of performing a short-range wireless communication such as a wireless LAN or Bluetooth (registered trademark) with a short-range communication section 33 mounted on the vehicle 30 passing through the entrance/exit gate 81. The wireless communication section 82a receives identification information for identifying the vehicle 30 or the user thereof from the short-range communication section 33 of the vehicle 30 passing through the entrance/exit gate 81. In the present embodiment 1, for example, vehicle identification information for identifying the vehicle 30 is transmitted from the short-range communication section 33 of the vehicle 30 to the wireless communication section 82a of the gate apparatus 82.

The gate apparatus 82 of the present embodiment 1 only needs to acquire identification information that can identify the vehicle 30 passing through the entrance/exit gate 81 or the user thereof. Therefore, a method of the acquisition is not limited to the method of receiving the identification information transmitted from the vehicle 30 by the wireless communication section 82a as described above. For example, a license plate (vehicle registration number certificate) of the vehicle 30 passing through the entrance/exit gate 81 is imaged using an imaging apparatus such as a camera, and the vehicle registration number of the vehicle 30 recognized from the obtained image is acquired as identification information. In addition, identification information of the vehicle received from an ETC (Electronic Toll Collection System) in-vehicle equipment installed in the vehicle may be used.

It is noted that, although the identification information of the vehicle 30 acquired by the gate apparatus 82 is eventually used for identifying the vehicle 30 in the server 100 of this system, it does not need to be the identification information itself used for processing in the server 100. That is, the identification information of the vehicle 30 acquired by the gate apparatus 82 may be identification information in a different format associated with the identification information used for processing in the server 100.

When the gate apparatus 82 acquires the identification information of the vehicle 30 passing through the entrance/exit gate 81, the external communication section 82b transmits the identification information to the server 100 via a communication network 60 such as a mobile communication network or the Internet. Herein, entering/exiting information for distinguishing between entering and exiting the parking place 80 and identification information (identification information of service provision area) for identifying the parking place 80 or the gate apparatus 82 are also transmitted. In the present embodiment 1, an example in which parking identification information for identifying the parking place 80 is used as the identification information of service provision area will be described.

The vehicle 30 can perform the short-range wireless communication with the wireless communication section 82a of the gate apparatus 82 by the short-range communication section 33 mounted on the vehicle, and communicate with the server 100 via the communication network 60 by the external communication section 32 mounted on the vehicle. The external communication section 32 and the short-range communication section 33 may be, for example, a remote control unit (TCU: Telematics Control Unit) connected to an in-vehicle network (CAN: Controller Area Network) via a gateway. The in-vehicle network (CAN) is connected to a battery management system (BMS) that manages the battery 31 and one or more electronic control units (ECU) that control other parts, in addition to the remote control unit (TCU).

Power usage information (for example, battery identification information, amount of electric power, power-charging start time, power-charging end time, etc.) regarding the electric power used for charging the battery 31 can be transmitted, for example, from the battery management system (BMS) to the server 100 via the remote control unit (TCU). Vehicle identification information can be transmitted, for example, from the electronic control unit (ECU) having a memory storing basic information of the vehicle, to the server 100 and the gate apparatus 82 via the remote control unit (TCU).

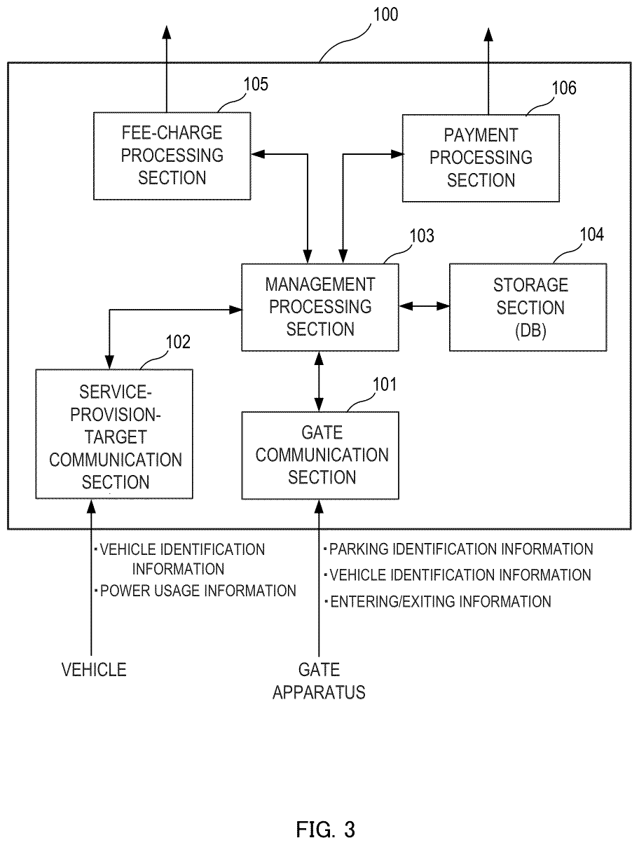

FIG. 3 is a block diagram showing an example of a configuration of main functions of the server 100 according to the embodiment 1. In FIG. 3, the server 100 includes a gate communication section 101, a service-provision-target communication section 102, a management processing section 103, a storage section (DB: database) 104, a fee-charge processing section 105, and a payment processing section 106.

The gate communication section 101 receives the parking identification information (identification information of service provision area) for identifying the parking place 80 from the gate apparatus 82 disposed in each parking place 80 (service provision area) via the communication network 60, as well as the vehicle identification information and the entering/exiting information of the vehicle 30 entering or exiting the parking place 80. The gate communication section 101 functions as a detection section, and by receiving such information, can detect the vehicle 30 that is the service provision target existing inside the parking place, or the user, in each parking place 80 (service provision area).

The service-provision-target communication section 102 has a function as a supply information acquisition section, and receives, from the vehicle 30 that is the service provision target, the vehicle identification information that is the identification information of the service provision target and the power usage information (for example, battery identification information, amount of electric power, power-charging start time, power-charging end time), as the supply information, that is supplied from the electrical outlet 20 to the battery 31 of the vehicle 30.

In the present embodiment 1, in order to calculate a usage fee (fee to be charged to the user) and a provision fee (fee to be paid to a charging service business-operator) for the electric power of the electrical charging service, although the power usage information is received and acquired by the service-provision-target communication section 102, other acquisition methods may be used. For example, if the power usage information of the vehicle 30 is stored and managed in a vehicle management server of a vehicle manufacturer in association with the identification information of the vehicle 30, the power usage information may be acquired from the vehicle management server.

In addition, in order to calculate the usage fee and the provision fee for the electric power of the electrical charging service, it is necessary to grasp information (supply amount information) on the amount of electric power (power supply amount) supplied to the vehicle 30. For example, if the detection section provided on a side of the vehicle 30 or the electrical outlet 20 can directly detect the amount of electric power (power supply amount) charged to the battery 31 from the electrical outlet 20, the information on the detected amount of electric power can be used as the supply amount information.

Furthermore, for example, if the detection section provided on the vehicle 30 is capable of detecting a remaining power amount in the battery 31, information on the detected remaining power amount may be used as the supply amount information. In this case, for example, by subtracting the remaining power amount before charging from the remaining power amount after charging, it is possible to obtain the amount of electric power (power supply amount) charged to the battery 31 from the electrical outlet 20.

Moreover, since many electric vehicles are equipped with the detection section that detects a power-charging rate (SoC: State of Charge) of the battery 31, SoC data may be used as the supply amount information. In this case, unless a full charge capacity of the battery 31 is known, the remaining power amount of the battery 31 cannot be determined from the SoC data. However, by storing a correspondence relation between the identification information of the battery 31 and the full charge capacity in the storage section (DB) 104, the full charge capacity can be specified from the identification information of the battery 31, and the remaining power amount of the battery 31 can be calculated from the SoC data of the battery 31.

In the present embodiment 1, the gate communication section 101 and the service-provision-target communication section 102 may be configured as an integrally configured communication apparatus (for example, a mobile communication module).

The management processing section 103 performs various types of process such as an association process for associating the parking identification information that is the identification information of the service provision area, the vehicle identification information that is the identification information of the service provision target, parking usage information, and the power usage information, an authentication process of the service provision target (the vehicle 30 or the user thereof), a parking-usage management process for managing the parking usage information for each service provision target, and a service management process for managing the power usage information for each user or service provision target.

As the association process in the present embodiment 1, the management processing section 103 registers the parking identification information, the vehicle identification information and the entering/exiting information received by the gate communication section 101 from the gate apparatus 82 at an area stay database in the storage section 104. Specifically, it determines whether the vehicle has entered or exited based on the entering/exiting information. For example, in the entering case, the vehicle identification information is associated with the parking identification information and registered in the area stay database together with an entering time, and in the exiting case, an existing time is associated with the vehicle identification information and registered in the area stay database. As a result, the vehicle identification information of all the vehicles 30 existing (staying) in each of the parking places 80, and the entering time and the exiting time of all the vehicles 30 existing (staying) in each of the parking place, in which the electrical outlets 20 managed by the server 100 is disposed, is registered in the area stay database.

Further, as authentication process in the present embodiment 1, the management processing section 103 performs a user authentication which confirms whether the user is an authorized regular user registered in advance in a target service of the present embodiment by comparing the vehicle identification information received by the service-provision-target communication section 102 from each vehicle 30 with the vehicle identification information registered in advance in the server 100. Specifically, a user registration database that associates identification information of the regular user with authorized vehicle identification information is stored in the storage section 104, and after confirming that the vehicle identification information received by the service-provision-target communication section 102 from each vehicle 30 is registered in the user registration database, it is determined that the user of the received vehicle identification information is the regular user. In the case of regular user, the usage of the service may be permitted, and in the case of non-regular user, the usage of the service may be restricted (for example, usage is not permitted).

Furthermore, in the parking place usage management process in the present embodiment 1, the management processing section 103 refers to the area stay database in the storage section 104, and registers stay time information regarding a time when the each vehicle 30 stayed in the parking place 80, in a parking-usage management database, in association with the vehicle identification information of the vehicle 30 (or the identification information of the user associated with the vehicle identification information).

Herein, the management processing section 103 refers to the area stay database in the storage section 104, confirms in which parking place 80 the vehicle 30 corresponding to the vehicle identification information exists (stays), and acquires a parking-place identification information of the confirmed parking place 80. Then, the management processing section 103 refers to a business-operator database in the storage section 104, confirms which business-operator is a parking service business-operator corresponding to the parking-place identification information, acquires a business-operator identification information of the confirmed parking service business-operator, and registers the acquired business-operator identification information in the parking-usage management database together with the stay time information of the vehicle 30.

As the service management process in the present embodiment 1, the management processing section 103 registers the power usage information received by the service-provision-target communication section 102 from each vehicle 30, in the power-usage management database in the storage section 104. Specifically, a power amount information (supply amount information) included in the power usage information received from each vehicle 30 is associated with the vehicle identification information of the vehicle 30 (or the user identification information associated with the vehicle identification information), and registered in the power-usage management database.

Herein, the management processing section 103 refers to the area stay database in the storage section 104 and confirms in which parking place 80 the vehicle 30 corresponding to the vehicle identification information exists (stays), and then acquires the parking identification information of the confirmed parking place 80. Then, the management processing section 103 refers to the business-operator database in the storage section 104 and confirms which charging service business-operator corresponds to the parking identification information, and then acquires the business-operator identification information of the confirmed charging service business-operator and registers this business-operator identification information in the power-usage management database together with the power amount information (supply amount information) included in the power usage information received from the vehicle 30.

The business-operator database stored in the storage section 104 of the present embodiment 1 stores the parking identification information for identifying each parking place 80, the parking service business-operator as the provision business-operator that provides the time-rental parking service in each parking place 80, and the charging service business-operator as the provision business-operator that provides the power-usage management service by using the electrical outlets 20 disposed in each parking place 80 in association with each other.

The system of the present embodiment 1 may be a system in which the parking places 80 coexist, which are respectively managed by a plurality of the parking service business-operators.

Furthermore, the system of the present embodiment 1 may be a system in which the electrical outlets 20 coexist, which are respectively managed by a plurality of the charging service business-operators. However, in the present embodiment 1, the service provision area is set to include only the electrical outlets 20 managed by the same charging service business-operator. In other words, all outlets 20 of the five power-charging stands 25-1 to 25-5 disposed in the parking place 80 set as the service provision area, shown in FIG. 1, are used for a provision of the electrical charging service managed by the same charging service business-operator. By setting the service provision area in this way, it is possible to make a one-to-one correspondence between the service provision area and the charging service business-operator. As a result, even if it is not possible to individually identify the electrical outlet 20 that supplies the electric power to the battery 31 of the vehicle 30, as long as the service provision area (parking place 80) in which the supplying electrical outlet 20 is disposed can be grasped, it is possible to identify the charging service business-operator that manages the supplying electrical outlet 20.

Therefore, according to the system of the present embodiment 1, even in the case where the electrical outlets 20 coexist, which are respectively managed by a plurality of charging service business-operators, it is possible to obtain benefits such as less an equipment load and a processing load, with regard to identifying the provision business-operator when the electric power is supplied from the electrical outlet 20 to the battery 31 of the vehicle 30. In particular, in a distributed power source system, in a region where the plurality of charging service business-operators respectively manage and operate a power generation apparatus such as solar power generation apparatus, there are many cases where the electrical outlets 20 managed by each charging service business-operator coexist, the benefits by the present embodiment are large.

In particular, when detecting the vehicle 30 existing in the parking place 80 (service provision area) using the gate apparatus 82 disposed at the entrance/exit gate 81 of the parking place as in the present embodiment 1, it is possible to use equipment used in existing services such as a gate apparatus of a pay-parking (gate apparatus having a function of detecting vehicles 30 entering and exiting a parking place 80 (service provision area)). Therefore, in the present embodiment 1, it is possible to reduce the equipment load and the processing load.

In the present embodiment 1, the fee-charge processing section 105 performs a process necessary for charging the usage fee of the electric power used by the vehicle 30 via the electrical outlet 20, to the user. Specifically, in the power-usage management database in the storage section 104, based on the user identification information of each user and the power usage information (supply amount information, etc.) in associated with each other, for example, the total usage fee for the electrical charging service during a predetermined period (for example, one month) is calculated for each user. It is noted that this usage fee can be calculated by, for example, multiplying a total amount of supplied electric power by a unit price of the usage fee. Then, the fee-charge processing section 105 performs a process of adding up the usage fee for the parking service and the usage fee for the electrical charging service calculated for each user, and charging the added fee to each user.

Here, in a case where multiple types of services (parking service, electrical charging service, etc.) provided respectively by different business-operators are provided to vehicles (moving bodies) existing in the parking place 80 (service provision area) or their passengers (users), conventionally, each fee-charge process for usage fees of these services is performed separately for each service in regard to the same user. Therefore, the user must pay the fee for each service even though the services are provided at the same location (service provision area), which is inconvenient.

In the present embodiment 1, the fee-charge processing section 105 performs a process necessary for collectively charging the usage fees for two services, the parking service and the electrical charging service, which are provided to the vehicle 30 detected by using the gate apparatus 82 or the user thereof, to the user. As a result, the user can pay the usage fees for two services (parking service and electrical charging service) provided in the same parking place 80 (service provision area) at once, and a convenience is improved.

Furthermore, in the present embodiment 1, the payment processing section 106 performs a process necessary for paying the provision fee for providing the parking service, to the parking service business-operator. Specifically, in the parking-usage management database in the storage section 104, the stay time information of each vehicle associated with the business-operator identification information of each parking service business-operator is extracted, and the provision fee according to the extracted stay time information is calculated for each parking service business-operator. Then, the payment processing section 106 performs a process for paying each calculated provision fee to the corresponding parking service business-operator.

In the present embodiment 1, the payment processing section 106 also performs a process necessary for paying the provision fee for providing the electrical charging service, to the charging service business-operator. Specifically, in the power-usage management database in the storage section 104, the power usage information of each user associated with the business-operator identification information of each charging service business-operator is extracted, and the provision fee according to the extracted power usage information is calculated for each charging service business-operator. Then, the payment processing section 106 performs a process for paying each calculated provision fee to the corresponding charging service business-operator.

Here, in a case where multiple types of services (parking service, electrical charging service, etc.) provided respectively by different business-operators are provided to vehicles (moving bodies) existing in the parking place 80 (service provision area) or their passengers (users), conventionally, each provision business-operator respectively uses separate equipment to detect the service provision target (moving body or user) using the respective service, and collects the provision fee for the service from the user. Therefore, even though the services are provided in the same location (service provision area), it is necessary that each provision business-operator prepares equipment that can detect the service provision target (moving body or user) in duplicate, and performs a process for collecting the provision fee of the service from the user, which is inconvenient.

In the present embodiment 1, the payment processing section 106 performs a process necessary for respectively paying the provision fees for two services, the parking service and the electrical charging service, which are provided to the vehicle 30 detected by using the gate apparatus 82 or the user thereof, to each provision business-operator that provides these services. Thereby, in the present embodiment 1 in which the usage fees for two services (parking service and electrical charging service) provided in the same parking place 80 (service provision area) are collected (charged) from the user at once, the collected fees can be distributed to pay the respective provision fees to the respective provision business-operators that provides the respective services.

Moreover, in the present embodiment 1, each provision business-operator does not need to separately prepare and manage equipment for detecting the service provision target, and does not need to collect the provision fees of respective services from the user, and a convenience for each provision business-operator is improved.

It is noted that, in the present embodiment 1, although the management business-operator of the server 100 performs the process for collectively fee-charging the usage fee of the parking service and the electrical charging service, to the user, and the process for paying the provision fee of the parking service and the electrical charging service, to each provision business-operator, at least one of the processes may be performed by another business-operator. Specifically, when the former process is performed by another business-operator, the fee-charge processing section 105 of the server 100 performs a process for calculating a total fee of the usage fees for the parking service and the electrical charging service and providing the calculated total fee to the other business-operator, as the process necessary for fee-charging. In addition, when the latter process is performed by another business-operator, the payment processing section 106 of the server 100 performs a process for calculating the respective provision fees for the parking service and the electrical charging service and providing the calculated usage fee and the provision business-operator of payee, to the other business-operator, as the process necessary for payment.

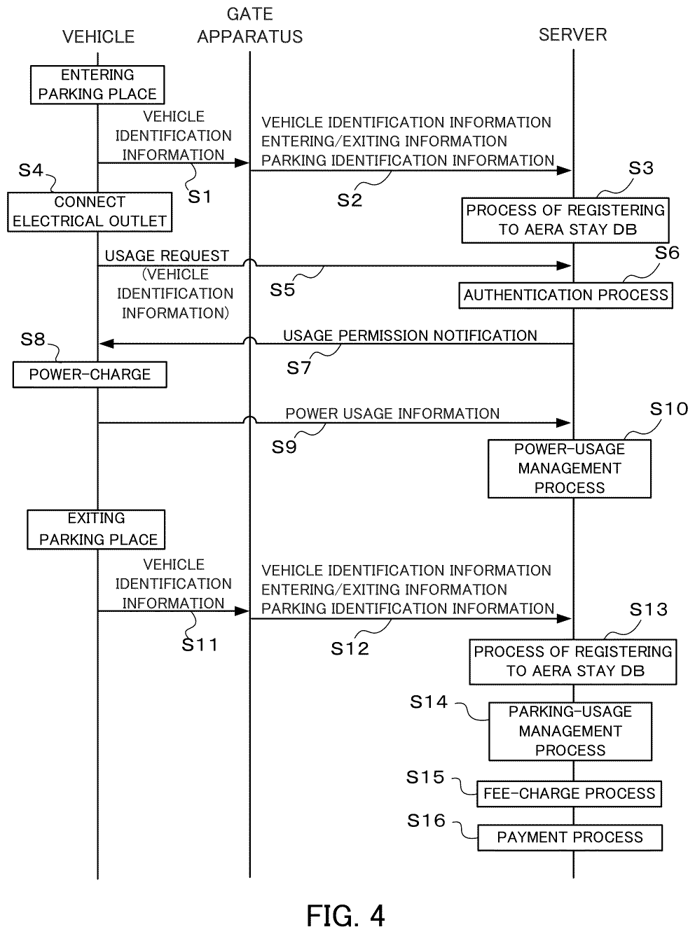

FIG. 4 is a sequence diagram showing an example of process in the service management system 10 of the present embodiment 1.

In the storage section 104 of the server 100, a data input to the user registration database is performed in advance by an operator, input information from a personal terminal of the user or the like, and then the storage section 104 stores the identification information of the authorized regular users, the vehicle identification information of the vehicles used by the users, the business-operator identification information of the provision business-operator of the parking-usage management service used by the user, and the business-operator identification information of the provision business-operator of the power-usage management service used by the user, in association with each other. Further, in the storage section 104 of the server 100, a data input to the business-operator database is performed in advance by an operator or the like, and then the storage section 104 stores identification information of the provision business-operators (parking service business-operator and charging service business-operator), the parking identification information of the parking places 80 managed by the parking service business-operator, the parking identification information of the parking places 80 in which the electrical outlets 20 managed by the charging service business-operator is disposed, in association with each other. When the vehicle 30 enters the parking place 80 through the entrance/exit gate 81 of the parking place 80, the gate apparatus 82 communicates with the short-range communication section 33 of the vehicle 30 by the wireless communication section 82a to receive the vehicle identification information of the vehicle 30 from the vehicle 30 (S1). Then, the gate apparatus 82 transmits the received vehicle identification information to the server 100 via the communication network 60 together with the entering/exiting information at the time of entering and the parking identification information of the parking place 80 by the external communication section 82b (S2).

The management processing section 103 of the server 100 registers the vehicle identification information, the entering/exiting information and the parking identification information received from the gate apparatus 82 by the gate communication section 101 in the area stay database in the storage section 104. Here, since the entering/exiting information indicates the time of entering, the vehicle identification information is registered in the area stay database in association with the parking identification information together with the entering/exiting information at the time of entering (S3).

Subsequently, when the vehicle 30 is parked at the parking space in the parking place 80 and receives electric power from the electrical outlet 20 of the power-charging stand 25 to charge the battery 31, a plug 41 of a power cable 40 of the vehicle 30 is connected to the electrical outlet 20 (S4). As a result, a usage request including the vehicle identification information of the vehicle 30 is transmitted from the external communication section 32 of the vehicle 30 to the server 100 via the communication network 60 (S5).

When this usage request is received by the service-provision-target communication section 102 of the server 100, an authentication process is executed in the management processing section 103 (S6). In this authentication process, it is confirmed whether or not the vehicle identification information included in the usage request belongs to the regular users registered in the user registration database in storage section 104.

Herein, even if the vehicle identification information included in the usage request is registered in the user registration database, it is necessary to confirm whether the electrical outlet 20 related to the usage request is managed by the charging service business-operator to which the user of the registered vehicle identification information registers. In this case, for example, the management processing section 103 of the server 100 first refers to the area stay database in the storage section 104 to confirm whether the vehicle identification information related to the usage request is registered. If it is confirmed that the vehicle exists in the parking place 80 through this confirmation, next, the parking identification information corresponding to the vehicle identification information related to the usage request is acquired from the area stay database, and the business-operator identification information of the corresponding charging service business-operator is acquired by referring the business-operator database in the storage section 104. If this business-operator identification information is registered in the user registration database in association with the user of the vehicle identification information related to the usage request, it can be confirmed that the user is the authorized regular user.

If it is confirmed that the user is the regular user by the above authentication process, the server 100 outputs a usage permission notification to the vehicle 30, which is the transmission source of the usage request, through the communication network 60 by the service-provision-target communication section 102 (S7). The vehicle 30, which received this usage permission notification, starts a power supply to the battery 31 from the electrical outlet 20 to which the plug 41 is connected, by the battery management system (BMS), thereby charges the battery 31 (S8).

If it is not possible to confirm that the user is the regular user, the server 100 outputs a usage non-permission notification to the vehicle 30 that is the transmission source of the usage request, through the communication network 60 by the service-provision-target communication section 102. In this case, the power-usage management service using the electrical outlet 20 may be disabled.

The battery management system (BMS) of the vehicle 30 generates the power usage information (amount of electric power, power-charging start time, power-charging end time, etc.) related to the electric power used to charge the battery 31. After the power-charging is completed, the power usage information is transmitted from the external communication section 32 of the vehicle 30 to the server 100 via the communication network 60 (S9). When this power usage information is received by the service-provision-target communication section 102 of the server 100, the management processing section 103 executes the service management process for registering the received power usage information in the power-usage management database in the storage section 104 (S10).

In the power-usage management process of the present embodiment 1, for the fee-charge process, at least the power amount information included in the power usage information received from the vehicle 30 is registered in the power-usage management database together with the vehicle identification information of the vehicle 30 and the business-operator identification information corresponding to the parking identification information of the parking place in which the vehicle 30 exists.

On the other hand, when the vehicle 30 exits the parking place 80 from the entrance/exit gate 81 of the parking place 80, the gate apparatus 82 communicates with the short-range communication section 33 of the vehicle 30 by the wireless communication section 82a to receive the vehicle identification information of the vehicle 30 from the vehicle 30 (S11). Then, the gate apparatus 82 transmits the received vehicle identification information to the server 100 via the communication network 60 together with the entering/exiting information at the time of exiting and the parking identification information of the parking place 80 by the external communication section 82b (S12). Then, the management processing section 103 of the server 100 registers the vehicle identification information, the entering/exiting information and the parking identification information, which are received from the gate apparatus 82 by the gate communication section 101, in the area stay database in the storage section 104. Herein, since the entering/exiting information indicates the timing of exiting, the entering/exiting information at the time of exiting is registered in the area stay database in association with the parking identification information and the vehicle identification information (S13).

Next, the management processing section 103 refers to the area stay database in the storage section 104, and performs the parking-usage management process that registers the stay time information regarding the time that the vehicle 30 stays in the parking place 80 in the parking-usage management database in association with the vehicle identification information of the vehicle 30 (S14).

Thereafter, the fee-charge processing section 105 of the server 100 performs a process necessary for collectively charging the usage fees of the parking service and the electrical charging service for the current vehicle 30, to the use corresponding to the vehicle 30 (S15). Specifically, it performs a process for adding the usage fee of electrical charging service, which is calculated with reference to the power-usage management database in the storage section 104, and the usage fee of parking service, which is calculated with reference to the parking-usage management database in the storage section 104 are added together, and charging the added fee to each user.

Furthermore, the payment processing section 106 of the server 100 performs a process necessary for paying the provision fee of the parking service and the provision fee of the electrical charging service for the current vehicle 30, to the provision business-operators of the respective services (S16). Specifically, it performs a process for calculating the provision fee of electrical charging service of each charging service business-operator with reference to the power-usage management database in the storage section 104, calculating the provision fee of parking service of each parking service business-operator with reference to the parking-usage management database in the storage section 104, and paying the calculated provision fees to each provision business-operator.

### Embodiment 2

Next, another embodiment of the present invention (hereinafter, this embodiment will be referred to as “embodiment 2”) is described.

In the above-described embodiment 1, the site of the parking place 80 that includes only the electrical outlets 20 managed by the same charging service business-operator is set as the service provision area A. The site of the parking place 80 such as a pay-parking is physically partitioned by objects such as walls, and the entrance/exit gate 81 of the parking place 80 is limited, thereby it is possible to manage the vehicle identification information of the vehicles 30 existing (staying) in the parking place 80 (service provision area A) in the area stay database by using the gate apparatus 82 disposed in the entrance/exit gate 81.

However, in the case where the electrical outlet 20 of the power-charging stand 25 is disposed in a place that is not physically partitioned, the entrance/exit point is not limited, thereby in a configuration such as the gate apparatus 82 that identifies and detects the vehicle 30 passing through the entrance/exit, the vehicle identification information of the vehicles 30 existing in the service provision area cannot be managed by the area stay database.

In addition, in the case where the electrical outlets 20 of the power-charging stands 25 managed by a plurality of charging service business-operators are mixed in the site of a physically partitioned parking place, it is necessary to set a plurality of service provision areas corresponding to each charging service business-operator in one parking place that is the service provision area of one parking service business-operator. Also in this case, in the configuration in which the gate apparatus 82 identifies the vehicle 30 passing through the entrance/exit of the parking place, the vehicle identification information of the vehicle 30 existing in each service provision area cannot be managed by the area stay database.

Therefore, in the present embodiment 2, the vehicle identification information of the vehicles 30 existing in the service provision area of the charging service is managed in the area stay database by a configuration different from that of the present embodiment 1 described above. Specifically, a geofence technology is used to set a virtual service provision area. The geofence technology is a technology that establishes a virtual boundary line on the ground and grasps communication terminals entering and exiting the service provision area partitioned by the boundary line. That is, in the present embodiment 2, the vehicle 30 existing in each service provision area is detected based on a position information of the vehicle 30 and a position information of the service provision area.

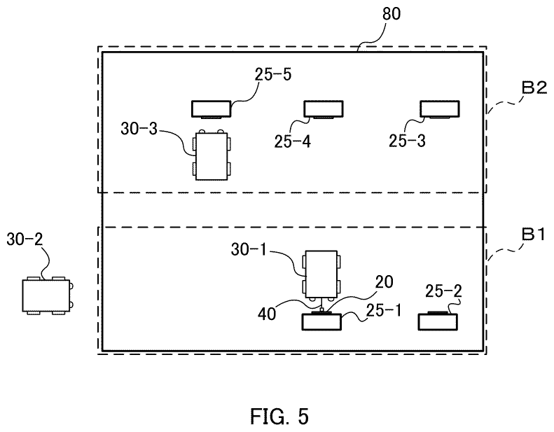

FIG. 5 is an explanatory diagram showing the service provision area in which the electrical outlets 20 is disposed, which configures the service management system 10 according to the present embodiment 2.

In the present embodiment 2, as shown in FIG. 5, two service provision areas B1 and B2 respectively corresponding to two charging service business-operators are set as geofence areas so that only electrical outlets 20 managed by the same charging service business-operator are included. Further, the two service provision areas B1 and B2 correspond to the site of the parking place provided by one parking service business-operator, and is equivalent to the service provision area A of the parking service.

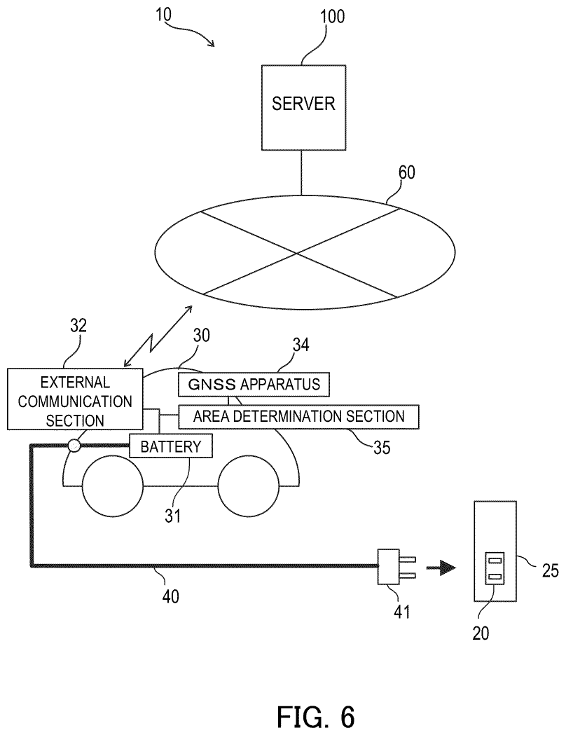

FIG. 6 is an explanatory diagram showing an example of the schematic configuration of the service management system 10 according to the present embodiment 2.

Each vehicle 30 is respectively equipped with a GNSS (Global Navigation Satellite System) apparatus 34, and can acquire positioning results obtained by positioning with the GNSS apparatus 34 as the position information. In addition, each vehicle 30 provided with an area determination section 35 which determines whether or not it has entered or exited the service provision area (each geofence area) B1 or B2 set in advance based on the positioning result (position information) obtained by positioning with the GNSS apparatus 34 provided by itself. In the area determination section 35, the position information of the service provision areas B1 and B2 set in advance is registered beforehand. The position information of the service provision areas B1 and B2, for example, may be received by the external communication section 32 from the server 100 via the communication network 60 and registered at a predetermined timing.

When the area determination section 35 of each vehicle 30 determines that it has entered the service provision area B1 or B2 based on the position information of the service provision area B1 or B2 and the positioning results (position information) obtained by the GNSS apparatus 34, it transmits an area entering notification including area identification information (identification information of the service provision area) for specifying the entered service provision area to the server 100. Also, when it determines that it has exited the service provision area B1 or B2, it transmits an area exiting notification including the area identification information for specifying the exited service provision area to the server 100.

It should be noted that although each vehicle 30 is provided with the area determination section 35 in the present embodiment 2, the server 100 may have a function of the area determination section 35.

Also in the present embodiment 2, the service provision area is set so as to include only the electrical outlets 20 managed by the same charging service business-operator. That is, the electrical outlets 20 of the two charging stands 25-1 to 25-2 disposed in the service provision area B1 shown in FIG. 5 is managed by the charging service business-operator G1 to provide the power-usage management service, and the electrical outlets 20 of the three charging stands 25-3 to 25-5 disposed in the service provision area B2 shown in FIG. 5 is managed by the charging service business-operator G2 to provide the power-usage management service.

By setting the service provision area in this way, a one-to-one correspondence is established between the service provision area and the charging service business-operator, thereby even if the electrical outlet 20 that has supplied power to the battery 31 of the vehicle 30 cannot be grasped individually, as long as the service provision areas B1 and B2 where the electrical outlet 20 is disposed can be grasped, it is possible to specify the charging service business-operator to manage the electrical outlet 20. Therefore, in the system of the present embodiment 2 as well, in identifying the charging service business-operator when electric power is supplied from the electrical outlet 20 to the battery 31 of the vehicle 30, merits such as less equipment load and less processing load can be obtained.

In particular, as in the present embodiment 2, by using the service provision area partitioned by the virtual boundary line such as the geofence, even in the case where the electrical outlet 20 of the power-charging stand 25 is disposed in a place that is not physically partitioned, the vehicles 30 existing in the service provision area can be grasped, and the vehicle identification information of the vehicles 30 existing in the service provision area can be managed by the area stay database.

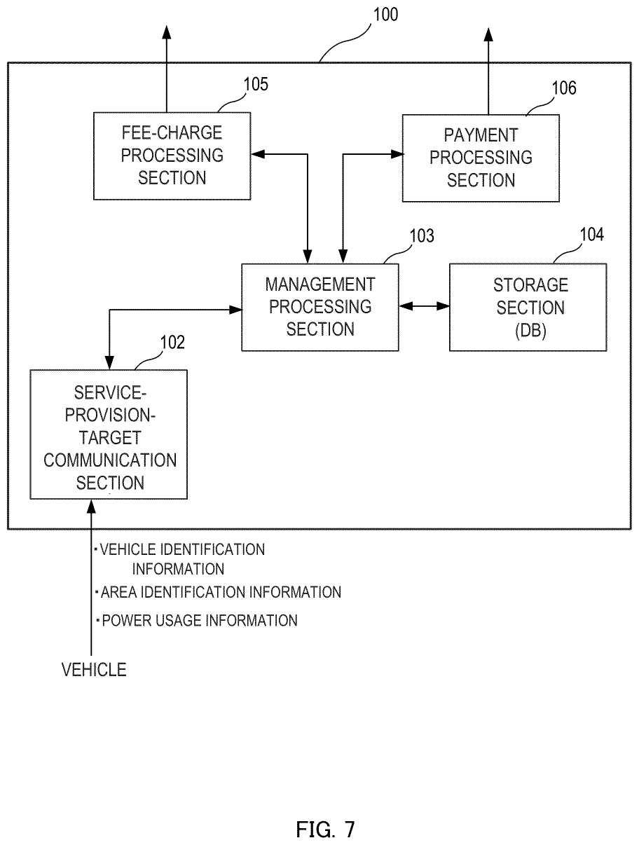

FIG. 7 is a block diagram showing an example of the configuration of main functions of the server 100 according to the embodiment 2.

In FIG. 7, the server 100 of the present embodiment 2 does not need to communicate with the gate apparatus 82, so it does not include the gate communication section 101, but other configurations are the same as those of the embodiment 1 as described above.

In the system of the present embodiment 2, a process of detecting the vehicle 30 existing in the service provision area can be realized by communication between the vehicle 30 and the server 100, thereby there is no need for communication between the gate apparatus 82 and the server 100, so the equipment load, etc. can be reduced.

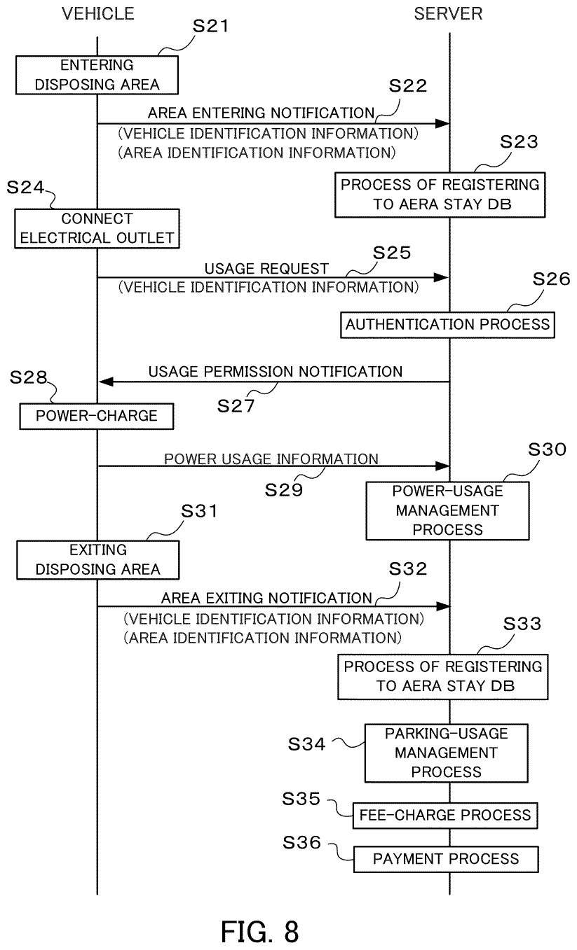

FIG. 8 is a sequence diagram showing an example of the power-usage management process in the embodiment 2.

When the vehicle 30 enters one of the service provision areas B1 and B2, the area determination section 35 of the vehicle 30 determines that it has entered the service provision area based on the position information of the service provision area B1 or B2 and the positioning result (position information) obtained by the GNSS apparatus 34 (S21). Then, from the external communication section 32 of the vehicle 30, an area entering notification including area identification information (identification information of the service provision area) for specifying the entered service provision area and the vehicle identification information of the vehicle 30 is transmitted to the server 100 via the communication network 60 (S22).

The management processing section 103 of the server 100 registers the vehicle identification information and the area identification information received from the vehicle 30 by the service-provision-target communication section 102 at the area stay database in the storage section 104. Here, since the vehicle has entered the service provision area, the vehicle identification information is registered at the area stay database together with the entering/exiting information at the time of entering, in association with the area identification information (S23).

Subsequently, when the vehicle 30 parks at the parking space in the parking place 80 corresponding to the service provision areas B1 or B2, and receives electric power from the electrical outlet 20 of the power-charging stand 25 in either service provision areas B1 and B2 to charge the battery 31, the plug 41 of the power cable 40 of the vehicle 30 is connected to the electrical outlet 20 (S24). As a result, a usage request including the vehicle identification information of the vehicle 30 is transmitted from the external communication section 32 of the vehicle 30 to the server 100 via the communication network 60 (S25). When this usage request is received by the service-provision-target communication section 102 of the server 100, the management processing section 103 executes authentication process similar to that of the embodiment 1 described above (S26).

If it is confirmed that the user is the authorized user by the authentication process, the server 100 outputs a usage permission notification to the vehicle 30, which is the transmission source of the usage request, through the communication network 60 by the service-provision-target communication section 102 (S27). The vehicle 30 received this usage permission notification starts power supply from the electrical outlet 20 to which the plug 41 is connected to the battery 31 by the battery management system (BMS), thereby charging the battery 31 (S28).

After the power-charging is completed, as in the embodiment 1 described above, the power usage information is transmitted from the external communication section 32 of the vehicle 30 to the server 100 via the communication network 60 (S29). When this power usage information is received by the service-provision-target communication section 102 of the server 100, as in the embodiment 1 described above, the management processing section 103 executes the power-usage management process for registering the received power usage information at the power-usage management database in the storage section 104 (S30).

On the other hand, when the vehicle 30 exits the service provision area B1 or B2, the area determination section 35 of the vehicle 30 determines that it has exited the service provision area based on the position information of the service provision area B1 or B2 and the positioning result (position information) obtained by the GNSS apparatus 34 (S31). Then, from the external communication section 32 of the vehicle 30, an area exiting notification including the area identification information (identification information of the service provision area) for specifying the exited service provision area and the vehicle identification information of the vehicle 30 is transmitted to the server 100 via the communication network 60 (S32). Then, the management processing section 103 of the server 100 registers the vehicle identification information and the area identification information received from the vehicle 30 by the service-provision-target communication section 102 from the area stay database in the storage section 104. Here, since the entering/exiting information indicates the time of exiting, the entering/exiting information at the time of exiting is registered in the area stay database in association with the vehicle identification information and the area identification information (S33).

Next, as in the embodiment 1 described above, the management processing section 103 refers to the area stay database in the storage section 104, and performs the parking-usage management process that registers the stay time information regarding the time that the vehicle 30 stays in the parking place 80 in the parking-usage management database in association with the vehicle identification information of the vehicle 30 (S34). Thereafter, the fee-charge processing section 105 and the payment processing section 106 of the server 100 perform the same process as in the embodiment 1 described above (S35, S36).

As described above, in the systems of in the embodiment 1 and 2 described above, the fee-charge processing section 105 of the server 100 performs a process necessary for collectively charging the usage fees of the two services, the parking service and the electrical charging service, which are provided to the vehicle 30 existing in the parking place 80 (service provision area) or the user thereof, to the user. Thereby, the usage fees for the two services (parking service and electrical charging service) provided in the same parking place 80 (service provision area) are collectively charged to the user. Therefore, the user can pay the usage fees for these services all at once, improving convenience for the user, and a convenience for the user is improved.

Furthermore, in the systems of in the embodiment 1 and 2 described above, the payment processing section 106 of the server 100 performs a process necessary for respectively paying the provision fees of the two services, the parking service and the electrical charging service, which are provided to the vehicle 30 existing in the parking place 80 (service provision area) or the user thereof, to each provision business-operator of these services. Thereby, the usage fees for two services (parking service and electrical charging service) provided in the same parking place 80 (service provision area) are distributed, and the respective provision fees can be paid to the respective provision business-operators that provides the respective services. Moreover, each provision business-operator does not need to separately prepare and manage equipment for detecting the service provision target, and does not need to collect the provision fees of respective services from the user, and a convenience for each provision business-operator is improved.

It is noted that, in the embodiment 1 and 2 described above, although a communication between the vehicle 30 and the server 100 is performed by using the external communication section 32 mounted on the vehicle 30, instead of such an external communication section 32 mounted on the vehicle, a terminal apparatus owned by the user may be used. As the terminal apparatus, for example, a mobile station (also referred to as a “mobile device”, a “user equipment (UE)”, etc.) capable of communicating via a mobile communication network of the fourth generation or the fifth generation or the later generation is used.

When the terminal apparatus possessed by the user is used instead of the external communication section 32 mounted on the vehicle, a user ID or the like used in an application running on the terminal apparatus can be used as identification information of the service provision target instead of the vehicle identification information. In case of using the terminal apparatus, as the identification information of service provision area, although for example, the positioning result (position information) obtained by positioning with the GNSS apparatus installed in the terminal apparatus can be used, other information may be used. For example, an imaging apparatus (camera) installed in the terminal apparatus reads the QR code (registered trademark) displayed near the electrical outlet 20 used for charging (power-charging stand 25 of the electrical outlet 20), and identification information included in this QR code (registered trademark) can be used as the identification information of the service provision area.

Also, when the terminal apparatus is used, the terminal apparatus needs to acquire the power usage information and the like from the side of the vehicle 30. In this case, for example, the transmission request generated by an application running on the terminal apparatus 51 is transmitted to the remote control unit (TCU) of the vehicle via short-range wireless communication, and is acquired from the remote control unit (TCU).

It is noted that process steps and configuration elements such as information processing apparatuses, gate apparatuses, in-vehicle apparatuses of vehicles, and terminal apparatuses described in the present specification can be implemented with various means. For example, these process steps and configuration elements may be implemented with hardware, firmware, software, or a combination thereof.

With respect to hardware implementation, means such as processing sections or the like used for establishing the foregoing steps and configuration elements in entities (for example, computer apparatus, server, gate apparatus, in-vehicle apparatus of vehicle, terminal apparatus (user equipment, mobile station, communication terminal), hard disk drive apparatus, or optical disk drive apparatus) may be implemented in one or more of an application-specific IC (ASIC), a digital signal processor (DSP), a digital signal processing device (DSPD), a programmable logic device (PLD), a field programmable gate array (FPGA), a processor, a controller, a microcontroller, a microprocessor, an electronic device, other electronic unit, computer, or a combination thereof, which are designed so as to perform a function described in the present specification.

With respect to the firmware and/or software implementation, means such as processing sections or the like for using to establish the foregoing configuration elements may be implemented with a program (for example, a code such as a procedure, a function, a module, an instruction, etc.) for performing a function described in the present specification. In general, any computer/processor readable medium of clearly materializing the code of firmware and/or software may be used for implementation of means such as processing sections and so on for establishing the foregoing steps and configuration elements described in the present specification. For example, in a control apparatus, the firmware and/or software code may be stored in a memory and executed by a computer or processor. The memory may be implemented within the computer or processor, or outside the processor. Further, the firmware and/or software code may be stored in, for example, a medium capable being read by a computer or processor, such as a random-access memory (RAM), a read-only memory (ROM), a non-volatility random-access memory (NVRAM), a programmable read-only memory (PROM), an electrically erasable PROM (EEPROM), a FLASH memory, a floppy (registered trademark) disk, a compact disk (CD), a digital versatile disk (DVD), a magnetic or optical data storage section, or the like. The code may be executed by one or more of computers and processors, and a certain aspect of functionalities described in the present specification may be executed by a computer or processor.

The foregoing medium may be a non-temporary recording medium. The foregoing code of the program may be readable and executable by a computer, processor, or other device or apparatus machine, and its format is not limited to a specific format. For example, the foregoing code of the program may be any of source code, object code, and binary code, or may be a mixture of two or more of these codes.

The description of embodiments disclosed in the present specification is provided so that the present disclosures can be produced or used by those skilled in the art. Various modifications of the present disclosures will be readily apparent to those skilled in the art and general principles defined in the present specification can be applied to other variations without departing from the spirit and scope of the present disclosures. Therefore, the present disclosures should not be limited to examples and designs described in the present specification and should be recognized to be in the broadest scope corresponding to principles and novel features disclosed in the present specification.

### REFERENCE SIGNS LIST

10: service management system
20: electrical outlet
25: power-charging stand
30: vehicle
31: battery
32: external communication section
33: short-range communication section
34: GNSS apparatus
35: area determination section
40: power cable
41: plug
51: terminal apparatus
60: communication network
80: parking place
81: entrance/exit gate
82: gate apparatus
82a: wireless communication section
82b: external communication section
100: server
101: gate communication section
102: service-provision-target communication section
103: management processing section
104: storage section
105: fee-charge processing section
106: payment processing section

1. An information processing system for performing an information processing regarding a service provided to a moving body or a user of the moving body as a service provision target, comprising:
a detection section for performing a detection of the service provision target existing in a service provision area where multiple types of services are respectively provided by a plurality of provision business-operators; and
a fee-charge processing section for performing a process necessary for fee-charging collectively usage fees of the multiple types of services provided to the service provision target detected by the detection section, to the user.

2. The information processing system according to claim 1, further comprising a payment processing section for performing a process necessary for paying provision fees of the multiple types of services provided to the service provision target detected by the detection section, to each of the plurality of provision business-operators.

3. An information processing system for performing an information processing regarding a service provided to a moving body or a user of the moving body as a service provision target, comprising:
a detection section for detecting the service provision target existing in a service provision area where multiple types of services are respectively provided by a plurality of provision business-operators; and
a payment processing section for performing a process necessary for paying provision fees of the multiple types of services provided to the service provision target detected by the detection section, to each of the plurality of provision business-operators.

4. The information processing system according to any one of claims 1 to 3, wherein the detection section performs the detection by acquiring detection information obtained by detecting a passage of the service provision target to the service provision area by a gate apparatus disposed at least one of an entrance and an exit of the service provision area.

5. The information processing system according to any one of claims 1 to 4, wherein the detection section performs the detection based on position information of the service provision target and position information of the service provision area.

6. The information processing system according to any one of claims 1 to 5, wherein the multiple types of services include at least one of a parking-space rental service for the moving body, an energy supply service to the moving body, and an additional service provided in conjunction with the energy supply service to the moving body.

7. The information processing system according to claim 6, wherein the additional service includes an energy rapid-supply service in which a fee-charging is performed for a use of rapid-supply of supplying an energy to the moving body at a high speed.

8. An information processing apparatus for performing an information processing regarding a service provided to a moving body or a user of the moving body as a service provision target, comprising a fee-charge processing section for performing a process necessary for fee-charging collectively usage fees of multiple types of services provided to the service provision target that is detected by a detection section as existing in a service provision area where the multiple types of services are respectively provided by a plurality of provision business-operators, to the user.

9. An information processing apparatus for performing an information processing regarding a service provided to a moving body or a user of the moving body as a service provision target, comprising a payment processing section for performing a process necessary for paying provision fees of multiple types of services provided to the service provision target that is detected by a detection section as existing in a service provision area where the multiple types of services are respectively provided by a plurality of provision business-operators, to each of the plurality of provision business-operators.

10. A method for performing an information processing regarding a service provided to a moving body or a user of the moving body as a service provision target, comprising:
performing a detection of the service provision target existing in a service provision area where multiple types of services are respectively provided by a plurality of provision business-operators; and
performing a process necessary for fee-charging collectively usage fees of the multiple types of services provided to the detected service provision target, to the user.

11. A method for performing an information processing regarding a service provided to a moving body or a user of the moving body as a service provision target, comprising:
detecting the service provision target existing in a service provision area where multiple types of services are respectively provided by a plurality of provision business-operators; and
performing a process necessary for paying provision fees of the multiple types of services provided to the detected service provision target, to each of the plurality of provision business-operators.
